(19) United States
(12) Patent Application Publication
(10) Pub. No.: US 2026/0142980 A1
(43) Pub. Date: May 21, 2026

(54) METHOD OF OPERATING A TELECOMMUNICATIONS SYSTEM

(71) Applicant: British Telecommunications Public Limited Company, London (GB)

(72) Inventor: Andrew REEVES, London (GB)

(21) Appl. No.: 19/121,764

(22) PCT Filed: Sep. 8, 2023
(86) PCT No.: PCT/EP2023/074746

§ 371 Date: Apr. 16, 2025

(30) Foreign Application Priority Data
Oct. 28, 2022 (GB) 2215975.0

(51) Int. Cl. H04L 9/40; H04L 9/32

(52) U.S. Cl. CPC H04L 63/12; H04L 9/3218

(57) ABSTRACT

A method of operating a telecommunications system (100), the telecommunications system comprising: a client device (110) storing a secret and an identifier; and a provisioning (140-1) server storing the secret and the identifier in association therebetween; an intermediary server (130) in communication with the provisioning server and the client device; the method comprising the steps of: performing, by means of the client device, a zero-knowledge proof operation upon the secret, thereby to output a first solution (220); communicating the identifier from the client device to the provisioning server via the intermediary server (230); performing, by means of the provisioning server, a zero-knowledge proof operation upon the secret associated with the received identifier, thereby to output a second solution (250); collecting the first solution and the second solution at the (260): intermediary server; client device; and/or provisioning server; comparing, by means of the intermediary server, client device and/or provisioning server, the first solution and the second solution (270); and in response to determining that the first solution and second solution are identical, identifying the provisioning server as a trusted provisioning server for configuring the client device (280).

### FIELD OF INVENTION

The present invention relates to a method of operating a telecommunications system, and in particular to a method for identifying a trusted provisioning server for a client device using zero knowledge proof of knowledge.

### BACKGROUND

Networked computing devices that access a network service, or client devices, are available to be remotely configured, or provisioned, by a remote server accessible over a telecommunications network. It is desirous that such provisioning is performed within a secure environment, where both the client device and server are trusted. To this end, the client device should be served only by a trusted provisioning server.

Given the volume of client devices requiring provisioning, especially with the rise of the “Internet of Things”, operating client devices to access the appropriate trusted provisioning server may be an onerous task. To help mitigate this burden, zero-touch provisioning has been devised, so that a client device can automatically identify and connect to the appropriate trusted provisioning server. For example, to help achieve zero-touch provisioning, a client device may be pre-configured, typically at the point of manufacture, with access details (such as a network address) for a trusted provisioning server. However, the period between manufacture and first provisioning of a client device may be significant, potentially months, if not years. In this period, the network address of the trusted provisioning server may change. As such, the static network address stored by the client device may no longer lead, directly or at all, to the trusted provisioning server, thereby scuppering zero-touch provisioning, and therefore efficient and/or effective operation of the client device.

It is an aim of the present invention to at least alleviate some of the aforementioned problems.

### STATEMENTS OF INVENTION

According to a first aspect of the present invention, there is provided: a method of operating a telecommunications system, the telecommunications system comprising: a client device storing a secret and an identifier; and a provisioning server storing the secret and the identifier in association therebetween; an intermediary server in communication with the provisioning server and the client device; the method comprising the steps of: performing, by means of the client device, a zero-knowledge proof operation upon the secret, thereby to output a first solution; communicating the identifier from the client device to the provisioning server via the intermediary server; performing, by means of the provisioning server, a zero-knowledge proof operation upon the secret associated with the received identifier, thereby to output a second solution; collecting the first solution and the second solution at the: intermediary server; client device; and/or provisioning server; comparing, by means of the intermediary server, client device and/or provisioning server, the first solution and the second solution; and in response to determining that the first solution and second solution are identical, identifying the provisioning server as a trusted provisioning server for configuring the client device.

Preferably, collecting the first solution and the second solution is performed by appropriate communication and/or retrieval from memory. Optionally, said communication is encrypted. Preferably, the secret is only known to the client device and the (trusted) provisioning server, and may never be communicated away from said devices.

Preferably, the first solution and the second solution are collected by the client device and/or provisioning server only by direct communication with the intermediary server. Optionally, the first solution and the second solution do not pass directly between the client device and the provisioning server.

Preferably, the method further comprises the step of the intermediary server communicating a client device network address to the provisioning server, said address being that of the client device. Optionally, the identifier is the client device network address. As used herein, a “network address” preferably comprises a physical, transport and/or network level address for locating a network entity, and may include a URL, IP, TCP and/or MAC address. The “network address” may also be unique. Preferably, the provisioning server has no prior knowledge of the client device network address.

Preferably, the method further comprising the step of the intermediary server communicating a provisioning server network address to the client device, said address being that of the provisioning server. Preferably, the client device has no prior knowledge of the provisioning server network address.

Preferably, the intermediary server identifies the trusted provisioning server, and wherein the intermediary server subsequently causes provisioning of the client device by the provisioning server. Optionally, the intermediary server causes said provisioning by communicating information or an instruction to the client device and/or to the provisioning server. Preferably, the provisioning server first identifies the trusted provisioning server; that is, before the client device and the provisioning server. Preferably, the intermediary server identifies the provisioning server as the trusted provisioning server in response to comparing the first solution and the second solution.

Preferably, the intermediary server causes the provisioning by communicating the client device network address to the provisioning server, thereby to cause establishment, by the provisioning server, of a direct connection with the client device.

Preferably, the intermediary server causes the provisioning by communicating the provisioning server network address to the client device, thereby to cause establishment of a direct connection, by the client device, to the provisioning server.

Preferably, the intermediary server causes the provisioning by retrieving, from the provisioning server, data for provisioning the client device, and the intermediary server communicating said data to the client device.

Preferably, the client device identifies the provisioning server as the trusted provisioning server, and the client device subsequently notifying the intermediary server of the identity of the trusted provisioning server. Optionally, the client device first identifies the trusted provisioning server; that is, before the intermediary server and the provisioning server. Preferably, the client device identifies the provisioning server as the trusted provisioning server in response to comparing the first solution and the second solution.

Preferably, the client device identifies the provisioning server as the trusted provisioning server, and wherein the client device subsequently uses the provisioning server network address so as to establish a direct connection with the provisioning server, thereby to cause provisioning of the client device by the provisioning server.

Preferably, the intermediary server collects the first and/or second solution/s in response to a request from the client device and/or from the provisioning server.

Preferably, the client device and/or provisioning server push the first and/or second solution/s to the intermediary server.

Preferably, the telecommunications system comprises a plurality of provisioning servers, in which only a subset are provided with the secret and identifier, and wherein the intermediary server communicates the identifier to all of the of provisioning servers. Preferably, only the subset are configured to provision the client device. Preferably, the population of provisioning servers that forms the plurality of provisioning servers is dynamic. Preferably, only servers in the subset are available to be identified as the trusted provisioning server. Optionally, there is available to be at least one trusted provisioning server.

Preferably, the client device is preconfigured with an intermediary server network address, said address being that of the intermediary server. Preferably, the client device is preconfigured without the, or any, provisioning server network address/es.

Preferably, the client device is preconfigured to access the intermediary server upon initialisation. Preferably, the client device performs the zero-knowledge proof function in response to a request from the intermediary server or upon initialisation.

Preferably, the telecommunications system further comprising an access point, wherein the intermediary server is in communication with the client device via the access point, and wherein the access point is preconfigured with a network address of the intermediary server, thereby to establish an initial connection between the client device and the intermediary server. Preferably, only the access point, and not the client device, is preconfigured with the intermediary server network address.

Preferably, the zero-knowledge operation comprises a Sigma protocol. Optionally, the client device is an Internet of Things device.

Preferably, the intermediary server is provided within a core or an edge of a telecommunications network. Preferably, the provisioning server is provided within a data network and outside of a, or the, core of a or the telecommunications network.

According to another aspect of the invention, there is provided a method of operating an intermediary server provided as part of a telecommunications system, said system further comprising a client device storing a secret and an identifier, and a provisioning server storing the secret and the identifier in association therebetween, the intermediary server being configured to communicate with the provisioning server and the client device, wherein the client device outputs a first solution by having performed a zero-knowledge proof operation upon the secret, and the method comprising the steps of: receiving the identifier from the client device; communicating the received identifier to the provisioning server, thereby to cause the provisioning server to output a second solution by performing a zero-knowledge proof operation upon the secret associated with the communicated identifier; collecting, via or by the intermediary server, the first solution and the second solution at the: intermediary server; client device; and/or provisioning server; receiving a result of a comparison of the first solution and the second solution; and in response to the result providing that the first solution and second solution are identical, identifying the provisioning server as a trusted provisioning server for configuring the client device.

According to another aspect of the invention, there is provided a method of operating a provisioning server provided as part of a telecommunications system, said system further comprising a client device storing a secret and an identifier, and an intermediary server being configured to communicate with the provisioning server and the client device, the provisioning server storing the secret and the identifier in association therebetween, and wherein the client device outputs a first solution by having performed a zero-knowledge proof operation upon the secret, and the method comprising the steps of: receiving, at the provisioning server, the identifier from the client device via the intermediary server; performing, by means of the provisioning server, a zero-knowledge proof operation upon the secret associated with the received identifier, thereby to output a second solution; collecting the first solution and the second solution at the: intermediary server; client device; and/or provisioning server; receiving a result of a comparison of the first solution and the second solution; and in response to the result providing that the first solution and second solution are identical, identifying, to the provisioning server, said provisioning server as a trusted provisioning server for configuring the client device.

According to another aspect of the invention, there is provided a client device provided as part of a telecommunications system, said system further comprising a provisioning server and an intermediary server, the intermediary server being configured to communicate with the provisioning server and the client device, wherein the client device stores a secret and an identifier, and wherein the provisioning server stores the secret and the identifier in association therebetween, the method comprising the steps of: performing, by means of the client device, a zero-knowledge proof operation upon the secret, thereby to output a first solution; communicating, by means of the client device, the identifier to the intermediary server and for onward communication to the provisioning server therefrom, thereby to cause the provisioning server to perform a zero-knowledge proof operation upon the secret associated with the received identifier, and in turn to output a second solution; collecting the first solution and the second solution at the: intermediary server; client device; and/or provisioning server; receiving a result of a comparison of the first solution and the second solution; and in response to the result providing that the first solution and second solution are identical, identifying, to the client device, the provisioning server as a trusted provisioning server for configuring the client device.

According to yet another aspect of the invention, there is provided a computer-readable carrier medium comprising a computer program, which, when the computer program is executed by a computer, causes the computer to carry out any one of the methods described above.

According to another aspect of the invention, there is provided a telecommunications system comprising: a client device comprising: first memory for storing a secret and an identifier; and a first processor for performing a zero-knowledge proof operation upon the secret, thereby to output a first solution; and a first transceiver for communicating the identifier from the client device; a provisioning server comprising: second memory for storing the secret and the identifier in association therebetween; a second transceiver for receiving the identifier; a second processor for identifying, in association with the received identifier, the secret associated therewith and subsequently to perform a zero-knowledge proof operation upon the identified secret, thereby to output a first solution; an intermediary server comprising a third transceiver for communicating with the provisioning server and the client device, including communicating the identifier from the client device to the provisioning server, and for receiving and communicating the first solution and/or the second solution; a receiver for collecting the first solution and the second solution; a third processor for comparing the collected first solution and the second solution, and for identifying, in response to the processor determining that the first solution and second solution are identical, the provisioning server as a trusted provisioning server for configuring the client device. Optionally, the receiver is a part of the first, second or third transceiver. Optionally, the third processor is a part of the first or second processor, or a part of the intermediary server.

According to another aspect of the invention, there is provided a telecommunications system configured to perform any one of the corresponding methods described above.

According to another aspect of the invention, there is provided an intermediary server configured to perform any one of the corresponding methods described above.

According to another aspect of the invention, there is provided a client device configured to perform any one of the corresponding methods described above.

According to another aspect of the invention, there is provided a provisioning server configured to perform any one of the corresponding methods described above.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method of operating a telecommunications system, a method of operating an intermediary server, a method of operating a client device, a method of operating a provisioning server, a telecommunications system, an intermediary server, a provisioning server, and a client device as described herein and/or substantially as illustrated with reference to the accompanying drawings. The present invention is now described, purely by way of example, with reference to the accompanying diagrammatic drawings, in which:

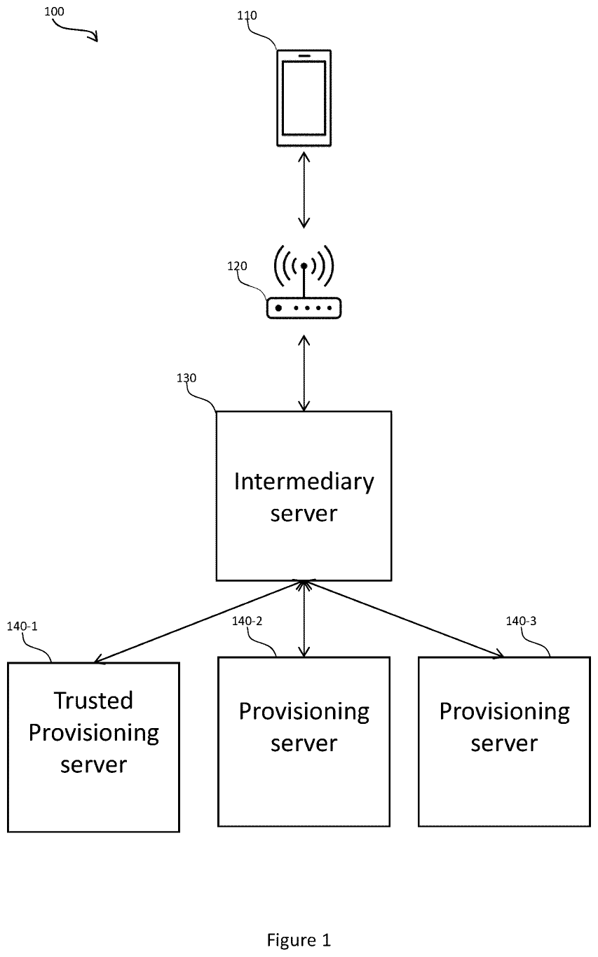

FIG. 1 shows a telecommunications system; and

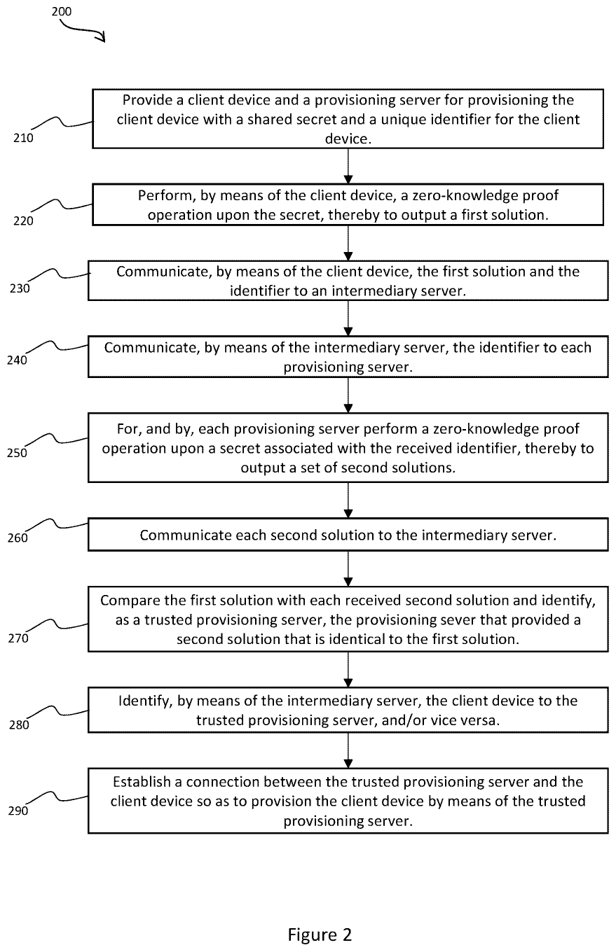

FIG. 2 shows a process for operating the telecommunications system.

### SPECIFIC DESCRIPTION

FIG. 1 shows a telecommunications system 100 comprising a/an: client device 110; access point 120; intermediary server 130; and a plurality of provisioning servers 140. The telecommunications system is interconnected by means of a telecommunications network (not shown).

The client device is available to be in the form of any electronic communications device, and in particular a/an: personal computer (laptop or desktop); mobile telecommunications device; Internet of Things (IoT) device; and/or network access point.

In one example, the access point 120 is a/an: cellular base station (such as a gNodeB), wireless router, gateway, extender and/or repeater. In any event, the access point provides access to the telecommunications network.

The client device is configured to connect to the access point, and therefore to the telecommunications network. Communication therebetween is available to use a wireless or wired interface. Where a wireless interface is used, said interface forms a part of a wide or local area network, such as a cellular network based on 3GPP standards or a Wi-Fi® network based on the IEEE® 802.11 family of standards, respectively.

The intermediary server is configured to identify and communicate, via the telecommunications network, with each of the plurality of provisioning servers. The intermediary server is therefore a directory of provisioning servers, which is compiled by the plurality of provisioning servers registering with the intermediary server so as to identify themselves as a provisioning server. The intermediary server is also accessible to the client device.

The intermediary server is provided as part of the telecommunications network, such as within a core or edge of said network, or a data network (not shown) outside of, but accessible via, the telecommunications network. In one example, the intermediary server is owned and/or operated by a telecommunications network operator, such as an Internet Service Provider.

The plurality of provisioning servers are a set of servers configured to provision client devices, and are provided as part of the data network. In this example, each provisioning server is configured to provision a different set of client devices (of which, only one such set is shown in FIG. 1). As such, the client device is unavailable to be provisioned by any and all of the provisioning servers. Instead, amongst the plurality of provisioning servers there is provided a single trusted provisioning server that is specifically dedicated and authorised to provision the client device.

To help securely identify the client device and the corresponding trusted provisioning server without the client device having prior knowledge of the trusted provisioning server, the client device and the trusted provisioning server (but not the remaining provisioning servers) are preconfigured to store, in association with one another: a common, shared, secret (or a “pre-known key”); and a unique identifier of the client device. Furthermore, the client device and the trusted provisioning server are configured to use the same Zero-Knowledge Proof of Knowledge (ZKPK) process, such as according to the Sigma protocol.

The secret is an item of data, known only to the client device and the trusted provisioning server (and any other trusted party). To help ensure secrecy, the secret is intended not to be communicated away from the client device and the trusted provisioning server. The item of data is available to be in the form of a password, passcode, passphrase, number, and/or an array of numbers.

The unique identifier of the client device is available to be a network address, International Mobile Subscriber Identity and/or International Mobile Equipment Identity. The unique identifier is available to be an open, non-secret, identifier, and the secret is not openly derivable from the unique identifier. The identifier is available to be unique amongst all identifiers across all provisioning servers, or amongst only all identifiers stored in the trusted provisioning server.

By means of the features described above, and according to the process described below, the intermediary server is available to act as a static point for the client device securely to discover and then access the trusted provisioning server, without the client device having to be preconfigured with explicit knowledge of the trusted provisioning server. Since the intermediary server is available to fulfil a matchmaking role between pluralities of different client devices and trusted provisioning servers, the intermediary server acts as a universal central broker.

FIG. 2 shows an exemplary process 200 of operating the telecommunications system so as securely to identify the trusted provisioning server to the client device, and/or vice versa, without the client device having prior knowledge as to the identity of the trusted provisioning server.

In a first step 210, the client device and the trusted provisioning server are provided with the same, shared, secret, and the unique identifier of the client device. In one example, the client device creates or is provided with the secret and/or the unique identifier at the point of production, which in turn is/are shared with the trusted provisioning server. The shared secret is available to be generated based on a hardware or software root of trust.

At a next step 220, the client device performs the ZKPK operation upon the secret so as to output a first solution. The first solution is available to be open and non-secret, and is only cryptographically derivable from the secret.

At a next step 230, the client device communicates the first solution and the unique identifier, in association with one another, to the intermediary server. To do so, the client device is preconfigured with a network address of the intermediary server, such as a URL. The client device, having connected to the access point, establishes a connection with the intermediary server using the network address. In one example, the access point and/or the telecommunications network is configured to resolve the network address to the intermediary server.

At a next step 240, the intermediary server polls the provisioning servers by communicating to each of the provisioning servers (including the—as yet unknown—trusted provisioning server) the unique identifier received from the client device.

At a next step 250, in response to receiving the unique identifier, each provisioning server performs a look-up operation to identify a secret associated with the received unique identifier. Where a provisioning server stores an associated secret against the received unique identifier, each such provisioning server performs a ZKPK operation upon the secret, thereby each to output a second solution, altogether the second solutions form a set of (at least one) second solutions.

At a next step 260, each provisioning server that outputs a second solution communicates said solution to the intermediary server, along with an identifier of the provisioning server (also referred to as a “provisioning server identifier” or a “provisioning server network address”), such that the intermediary server compiles the set of second solutions and the associated identity of the provisioning server from which each second solution originated.

At a next step 270, the intermediary server then compares each of the second solutions within the set of second solutions to the first solution. Where the intermediary server identifies a provisioning server that has provided a second solution that is identical to the first solution, the intermediary server identifies said provisioning server as the trusted provisioning server for the client device. In this way, the intermediary server acts to verify that the client device and the trusted provisioning server both have knowledge of the secret (without the intermediary gaining knowledge of the secret), and that the two entities may therefore trust one-another. Identifying a provisioning server as being trusted means authorising a client device to communicate with, and to be configured by, said server.

It will be appreciated that any provisioning server that does not respond with a second solution (e.g. because there is no secret associated with the received unique identifier), is unavailable to be identified as the trusted provisioning server. Likewise, any provisioning server that responds with a second solution that does not match the first solution (e.g. because a different secret and/or ZKPK operation is used to that of the client device, such as because the unique identifier is not universally unique) is also not identified as the trusted provisioning server.

Accordingly, at a next step 280, the intermediary server identifies the trusted provisioning server to the client device and/or vice versa. To do so, the intermediary server communicates the network address of the client device and/or of the trusted provisioning server to the other. In this way, the client device and trusted provisioning server are now available to establish a direct connection therebetween to allow secure provisioning of the client device.

At a final step 290, the client device and the trusted provisioning server establish a direct network connection via the telecommunications network, and the trusted provisioning server performs provisioning of the client device.

Such provisioning is available to include communicating data, including software and/or firmware updates, and configuring an operational parameter of the client device, such as a security and/or network parameter.

### Alternatives and Modifications

In an alternative, the client device is configured first to identify the trusted provisioning server. To do so, the set of second solutions are communicated to, and collected by, the client device, in association with the corresponding provisioning server identifier. The client device subsequently compares the first and second solutions to identify the identical pair of first and second solutions, and therefore to identify the trusted provisioning server. The client device then identifies the trusted provisioning server to the intermediary server (using the associated identifier) so that the intermediary server can communicate with the trusted provisioning server so as to establish a connection with the client device, as per step 290.

In an alternative, identification of the trusted provisioning server is performed by the plurality of provisioning servers by communicating the first solution from the client device to each provisioning server, via the intermediary server. Each provisioning server subsequently compares the first solution with the second solution generated, as appropriate, by the provisioning server performing said comparison. The trusted provisioning server is then available to identify itself as such for the client device (identified from the unique identifier of the client device, having been provided to each provisioning server to generate the second solution) to the intermediary server so that the intermediary server can communicate with the trusted provisioning server so as to establish a connection with the client device, as per step 290.

In an alternative, the provisioning server identifier and//or unique identifier of the client device is/are a network address of the provisioning server and/or client device. Accordingly, the client device and/or trusted provisioning server is/are available directly to establish a connection with the trusted provisioning server and/or client device, respectively, once identified.

In an alternative, where the intermediary server first identifies the trusted provisioning server, knowledge of said identity is retained only by the intermediary server. To provision the client device, the intermediary server instructs the trusted provisioning server to communicate data for provisioning the client device to the intermediary server, which the intermediary server then communicates on to the client device. In this way, the intermediary server also acts as a relay or proxy for provisioning of the client device.

Although FIGS. 1 and 2 are shown and described with reference to there being only one of the client devices, it will be appreciated that the telecommunications system 100 is available to comprise a plurality of client devices, each of which is configured in a corresponding, but not identical, way to the client device (i.e. having a secret, unique identifier, capability to perform a ZKPK operation, knowledge of the intermediary server, and having an associated trusted provisioning server). Accordingly, the intermediary server is configured to have a many-to-many relationship between client devices and provisioning servers.

In an alternative, the client device is a group of at least two client devices each having the same unique identifier and secret, and therefore each member of said group having the same trusted provisioning server. Once the trusted provisioning server is identified for one of the client devices in the group according to process 200, or alternatives, as appropriate, the same trusted provisioning server is available to be identified by the intermediary server for the remaining client devices in the group upon submission of the first solution and a determination that the first solution matches a previously provided second solution, thereby allowing steps 240 to 260 to be bypassed.

In one example, the intermediary server comprises a group of at least two associated servers, and may be in the form of a distributed computing system.

In an alternative, the intermediary server is configured sequentially to poll individual, or subsets, of the provisioning servers, thereby repeating steps 240 to 270 for each polled provisioning servers until the trusted provisioning server is identified.

Although FIGS. 1 and 2 show and describe only three provisioning servers, one of which is the trusted provisioning server for the client device, it will be appreciated that there can be at least one provisioning server and at least one trusted provisioning server. This includes the possibility of there only being one provisioning server that is also the trusted provisioning server, or there being a plurality of provisioning servers within which there are multiple trusted provisioning servers for the client device.

Each feature disclosed herein, and (where appropriate) as part of the claims and drawings may be provided independently or in any appropriate combination.

Any reference numerals appearing in the claims are for illustration only and shall not limit the scope of the claims.

1. A method of operating a telecommunications system, the telecommunications system comprising:
a client device storing a secret and an identifier; and
a provisioning server storing the secret and the identifier in association therebetween;
an intermediary server in communication with the provisioning server and the client device;
the method comprising the steps of:
performing, by means of the client device, a zero-knowledge proof operation upon the secret, thereby to output a first solution;
communicating the identifier from the client device to the provisioning server via the intermediary server;
performing, by means of the provisioning server, a zero-knowledge proof operation upon the secret associated with the received identifier, thereby to output a second solution;
collecting the first solution and the second solution at the:
intermediary server;
client device; and/or
provisioning server;
comparing, by means of the intermediary server, client device and/or provisioning server, the first solution and the second solution; and
in response to determining that the first solution and second solution are identical, identifying the provisioning server as a trusted provisioning server for configuring the client device.

2. A method according to claim 1, wherein the first solution and the second solution are collected by the client device and/or provisioning server only by direct communication with the intermediary server.

3. A method according to claim 1, further comprising the step of the intermediary server communicating a client device network address to the provisioning server, said address being that of the client device.

4. A method according to claim 1, further comprising the step of the intermediary server communicating a provisioning server network address to the client device, said address being that of the provisioning server.

5. A method according to claim 1, wherein the intermediary server identifies the trusted provisioning server, and wherein the intermediary server subsequently causes provisioning of the client device by the provisioning server.

6. A method according to claim 5, wherein the intermediary server causes the provisioning by communicating the client device network address to the provisioning server, thereby to cause establishment, by the provisioning server, of a direct connection with the client device.

7. A method according to claim 5, wherein the intermediary server causes the provisioning by communicating the provisioning server network address to the client device, thereby to cause establishment of a direct connection, by the client device, to the provisioning server.

8. A method according to claim 5, wherein the intermediary server causes the provisioning by retrieving, from the provisioning server, data for provisioning the client device, and the intermediary server communicating said data to the client device.

9. A method according to claim 1, wherein the client device identifies the provisioning server as the trusted provisioning server, and the client device subsequently notifying the intermediary server of the identity of the trusted provisioning server.

10. A method according to claim 1, wherein the client device identifies the provisioning server as the trusted provisioning server, and wherein the client device subsequently uses the provisioning server network address so as to establish a direct connection with the provisioning server, thereby to cause provisioning of the client device by the provisioning server.

11. A method of operating an intermediary server provided as part of a telecommunications system, said system further comprising a client device storing a secret and an identifier, and a provisioning server storing the secret and the identifier in association therebetween, the intermediary server being configured to communicate with the provisioning server and the client device, wherein the client device outputs a first solution by having performed a zero-knowledge proof operation upon the secret, and the method comprising the steps of:
receiving the identifier from the client device;
communicating the received identifier to the provisioning server, thereby to cause the provisioning server to output a second solution by performing a zero-knowledge proof operation upon the secret associated with the communicated identifier;
collecting, via or by the intermediary server, the first solution and the second solution at the: intermediary server; client device; and/or provisioning server;
receiving a result of a comparison of the first solution and the second solution; and
in response to the result providing that the first solution and second solution are identical, identifying the provisioning server as a trusted provisioning server for configuring the client device.

12. A method of operating a provisioning server provided as part of a telecommunications system, said system further comprising a client device storing a secret and an identifier, and an intermediary server being configured to communicate with the provisioning server and the client device, the provisioning server storing the secret and the identifier in association therebetween, and wherein the client device outputs a first solution by having performed a zero-knowledge proof operation upon the secret, and the method comprising the steps of:
receiving, at the provisioning server, the identifier from the client device via the intermediary server;
performing, by means of the provisioning server, a zero-knowledge proof operation upon the secret associated with the received identifier, thereby to output a second solution;
collecting the first solution and the second solution at the: intermediary server; client device; and/or provisioning server;
receiving a result of a comparison of the first solution and the second solution; and
in response to the result providing that the first solution and second solution are identical, identifying, to the provisioning server, said provisioning server as a trusted provisioning server for configuring the client device.

13. A method of operating a client device provided as part of a telecommunications system, said system further comprising a provisioning server and an intermediary server, the intermediary server being configured to communicate with the provisioning server and the client device, wherein the client device stores a secret and an identifier, and wherein the provisioning server stores the secret and the identifier in association therebetween, the method comprising the steps of:
performing, by means of the client device, a zero-knowledge proof operation upon the secret, thereby to output a first solution;
communicating, by means of the client device, the identifier to the intermediary server and for onward communication to the provisioning server therefrom, thereby to cause the provisioning server to perform a zero-knowledge proof operation upon the secret associated with the received identifier, and in turn to output a second solution;
collecting the first solution and the second solution at the: intermediary server; client device; and/or provisioning server;
receiving a result of a comparison of the first solution and the second solution; and
in response to the result providing that the first solution and second solution are identical, identifying, to the client device, the provisioning server as a trusted provisioning server for configuring the client device.

14. A computer-readable carrier medium comprising a computer program, which, when the computer program is executed by a computer, causes the computer to carry out the steps of claim 1.

15. A telecommunications system comprising:
a client device comprising:
first memory for storing a secret and an identifier; and
a first processor for performing a zero-knowledge proof operation upon the secret, thereby to output a first solution; and
a first transceiver for communicating the identifier from the client device;
a provisioning server comprising:
second memory for storing the secret and the identifier in association therebetween;
a second transceiver for receiving the identifier;
a second processor for identifying, in association with the received identifier, the secret associated therewith and subsequently to perform a zero-knowledge proof operation upon the identified secret, thereby to output a first solution;
an intermediary server comprising
a third transceiver for communicating with the provisioning server and the client device, including communicating the identifier from the client device to the provisioning server, and for receiving and communicating the first solution and/or the second solution;
a receiver for collecting the first solution and the second solution;
a third processor for comparing the collected first solution and the second solution, and for identifying, in response to the third processor determining that the first solution and second solution are identical, the provisioning server as a trusted provisioning server for configuring the client device.
